(19) United States
(12) Patent Application Publication
(10) Pub. No.: US 2009/0183587 A1
(43) Pub. Date: Jul. 23, 2009

(54) Machine for selecting a throttle type using a selector switch handle lock out

(76) Inventor: John Weslie Amce, Bonita, CA (US)

Correspondence Address: HARRY V. MCGAHEY JR., 1532 SIXTH AVENUE, SAN DIEGO, CA, 92101, US

(21) Appl. No.: 12/218,697

(22) Filed: Jul. 17, 2008

Related U.S. Application Data
(60) Provisional application No. 60/961,002, filed on Jul. 18, 2007.

(51) Int. Cl. G05G 11/00

(52) U.S. Cl. 74/489

(57) ABSTRACT

A machine for easily and quickly selecting between a thumb throttle and a twist throttle on a vehicle using a selector switch handle lock out.

### CROSS REFERENCE TO RELATED APPLICATIONS

This application claims priority from U.S. Provisional Patent Application No. 60/961,002 filed Jul. 18, 2007

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of vehicle throttle control and more specifically to a machine for easily selecting a throttle type while using the vehicle using a selector switch handle lock out.

How to be able to control the speed and engine of ATV's (All terrain vehicles) and other recreational vehicles for long periods of time safely without creating fatigue is a difficult problem. Examples of prior art include:

US Pat. Applic. No. 20030226418-A1 (Dec. 11, 2003 Howe) is a secondary twist handle throttle control for an ATV which uses a wire rope.

US Pat. Applic. No. 20030150287 (Aug. 14, 2003 Lev-Ran) is a throttle retrofit using a lever shoe to engage the thumb lever without lockout ability. A new complete unit must be used instead of merely adapting an existing thumb throttle control apparatus, and the user cannot switch back and forth by locking out one type of throttle when the other is being used, which is less safe than the subject invention herein described in this application.

U.S. Pat. No. 6,658,965 (Dec. 9, 2003 Allen) is a Lever Throttle Converter with a direct lever action using a finger-like projection.

U.S. Pat. No. 6,644,144 (Nov. 11, 2003 Bedard) is a rotatably mounted-throttle assembly.

U.S. Pat. No. 6,276,230 (Aug. 21, 2001 Crum et al.) is a handle bar throttle controller.

U.S. Pat. No. 6,167,776 (Feb. 2, 2001 Cossette) is an auxiliary throttle for snowmobiles and the like.

U.S. Pat. No. 5,775,167 (Jul. 7, 1998 Maietta) is a finger operated throttle lever.

U.S. Pat. No. 5,078,023 (Jul. 7, 1992 Scarborough) is a thumb-operated throttle control.

U.S. Pat. No. 4,838,113 (Jun. 13, 1989 Matsushima et al.) uses a shield to protect the fingers from cold when using a thumb throttle actuator for a vehicle.

U.S. Pat. No. 4,286,700 (Sep. 1, 1981 Morris et al.) is a motorcycle throttle control that when rotated in the opposite direction activates a brake.

U.S. Pat. No. 4,191,065 (Mar. 4, 1980 Golobay et al.) is a throttle twist grip.

U.S. Pat. No. 5,005,674 is a bicycle brake that ties a cable around a rotating handgrip so that twisting the hand grip pulls on the handlebar brake of the bicycle.

To date no one has invented an apparatus which allows a snowmobile, 4 Wheel Sport Quad Cycle Driver, Jet Ski, or similar vehicle to either choose a motorcycle type “twist throttle” or a “thumb operated throttle” to control speed with a positive safety lock out system by merely depressing and then pushing a switch on the handlebar either to the left or the right. This invention can be installed as original equipment or used on a vehicle without any extensive modifications or disassembly to the existing throttle assembly of the machine. Prior art does not meet this need as prior art either has dual throttles at the same time which are less safe than this subject invention, or time consuming changes must be made to the apparatus to switch from one type of throttle control to another.

### BRIEF SUMMARY OF THE INVENTION

The primary object of the invention is to provide a safer way of changing the method of controlling the throttle of recreational vehicles.

Another object of the invention is to provide a better way of controlling the throttle of recreational vehicles. for long periods of time without creating fatigue.

Another object of the invention is to provide a better way of safely controlling the speed of recreational vehicles for long periods of time.

Another object of the invention is to provide an improved method of adapting an existing recreational vehicle so that alternative methods of controlling its speed can be more quickly employed.

This is an invention which allows a snowmobile, 4 Wheel Sport Quad Cycle Driver, Jet Ski, or similar vehicle to either choose a motorcycle type “twist throttle” or a “thumb operated throttle” with a positive lock out handle to control speed by merely pushing a switch on the handlebar either to the left or the right which comprises the selector switch handle lock out. This can be done without any extensive modifications or disassembly to the existing throttle assembly of the machine. This is a much safer way to use alternate throttles than has been revealed in prior art.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows an orthogonal view of a basic factory thumb throttle as currently in use by many manufacturers.

FIG. 2 shows an orthogonal view of a basic factory thumb throttle as currently in use by many manufacturers with some of the parts numbered.

FIG. 3 shows an orthogonal view of the invention with the selector switch handle lock out installed.

FIG. 4a shows an orthogonal view of the invention installed with the selector switch handle lock out external parts numbered.

FIG. 4b is a top view of the throttle pull wheel.

FIG. 4c is a side view of the throttle pull wheel.

FIG. 4d is a side view of a select throttle cable adjustment clamp screw by itself.

FIG. 5 is an orthogonal exploded view of the with the selector switch handle lock out assembly.

FIG. 6a is an orthogonal exploded view of the with the selector switch handle lock out assembly.

FIG. 6b is a side view of the left half of the Outer Shell of the selector switch handle lock out assembly.

### REFERENCE NUMERALS IN DRAWINGS

10 Throttle Select Lock Out Switch
11 Twist Handle Grip
12 Crimped Cable Ferrule
13 Select Throttle Cable Adjustment Clamp Screw
14 The Channel Stop
15 Cable Anchor Point Assembly
16 Left Handle Bar Clamp Screw
17 Throttle Body Assembly Clamp Screws
18 Throttle Choice Selector Actuating Lever Screw
19 Throttle Cable Wiper
20 Twist Throttle Cable Stop
21 Left Side Channel & Stop for Selector Actuator Screw
22 Factory Top Plate Screws for securing the Control Box
23 Factory Throttle Adjustment screw
24 Standard Common Throttle Anchor Cable Bolts
25 Spool Cable Guide
26 Factory Control Box Clamp
27 Twist Throttle Cable
28 Cable Adjustment Clamp Nut
29 Left Half of the Outer Shell
30 Right Half of the Throttle Cable Cover Exit Orifice
31 Throttle Cable Cover Exit Orifice
32 Left Side of the Throttle Selector Channel
33 Right Side Channel of the Throttle Selector
34 Throttle Cable Channel
35 Through-holes for Assembly
36 The Standard Throttle Cable
37 Standard Cable Housing
38 Factory Control Box
39 Standard Handlebar
40 Factory Thumb Lever
41 Throttle Pull Wheel
42 Thumb Throttle Cable
43 Throttle Cable Housing
44 Left Half Outer Shell of Select Throttle Assembly
45 Right Half Outer Shell of Select Throttle Assembly
46 Left Half of Throttle Cable Cover Exit Orifice
47 Selector Switch Handle Lock out Flange

### DETAILED DESCRIPTION OF THE INVENTION

This invention is a machine for selecting a throttle type on a snowmobile, 4 Wheel Sport Quad Cycle Driver, Jet Ski, or similar vehicle using a selector switch handle lock out assembly.

The operator is able to either choose a motorcycle type “twist throttle” or a “thumb operated throttle” with a positive lock out handle to control speed by merely pushing a switch on the handlebar either to the left or the right by using this selector switch handle lock out assembly.

This can be done without any extensive modifications or disassembly to the existing throttle assembly of the machine.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

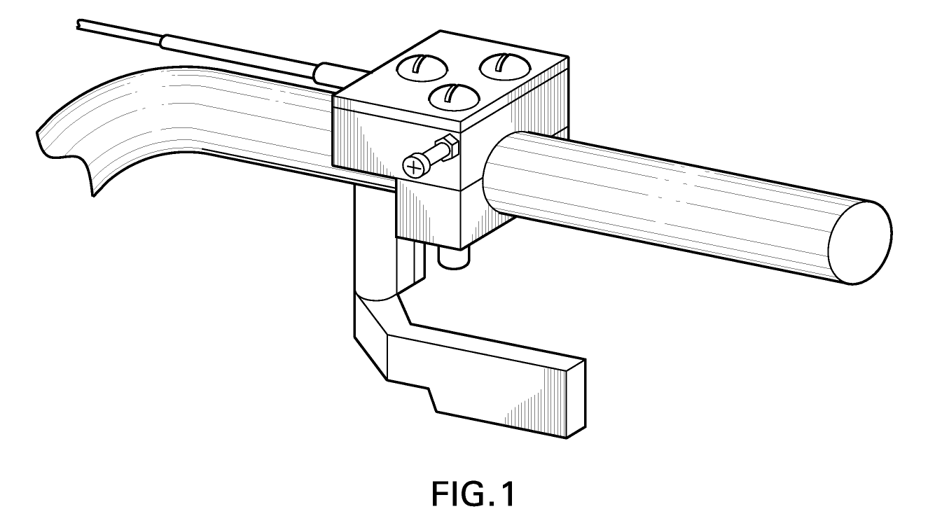

FIG. 1 shows an orthogonal view of a basic factory thumb throttle as currently in use by many manufacturers of recreational vehicles. This is the way a typical throttle assembly looks prior to installation of the select throttle.

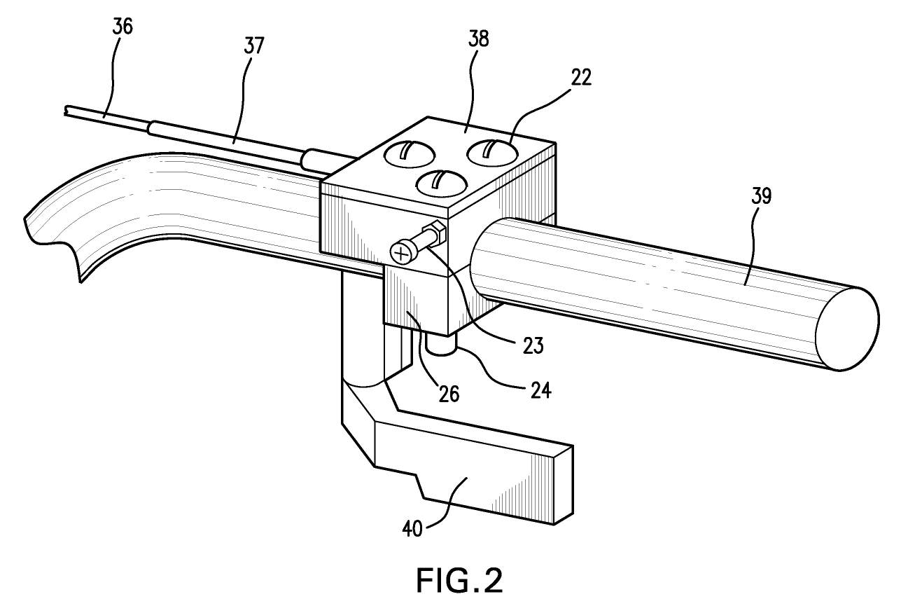

FIG. 2 shows an orthogonal view of a basic factory thumb throttle with many of the parts numbered. The Standard Throttle Cable (36) connected to an engine acceleration means (not shown) which remains as the first throttle cable when the invention is installed is enclosed inside a Standard Cable Housing (37) which is attached to a Factory Control Box (39). A plurality of Factory Top Plate Screws for securing the Control Box (22) can also be seen. A Standard Handlebar (39) extends out of the Factory Control Box (39). This Standard Handlebar is what is gripped by the driver and used to steer the vehicle. A typical Factory Thumb Lever (40) extends from the bottom of the Factory Control Box (39). This Factory Thumb Lever is always connected to the control box means so as to actuate the first throttle cable which is connected to the acceleration means for the vehicle.

The preferred embodiment has a Factory Throttle Adjustment screw (23) on the Factory Control Box (39). Standard Common Throttle Anchor Cable Bolts (24) used to secure the Factory Control Box Clamp (26) which anchors the Factory Control Box (39) to the Standard Handlebar (39) can also be seen at the bottom.

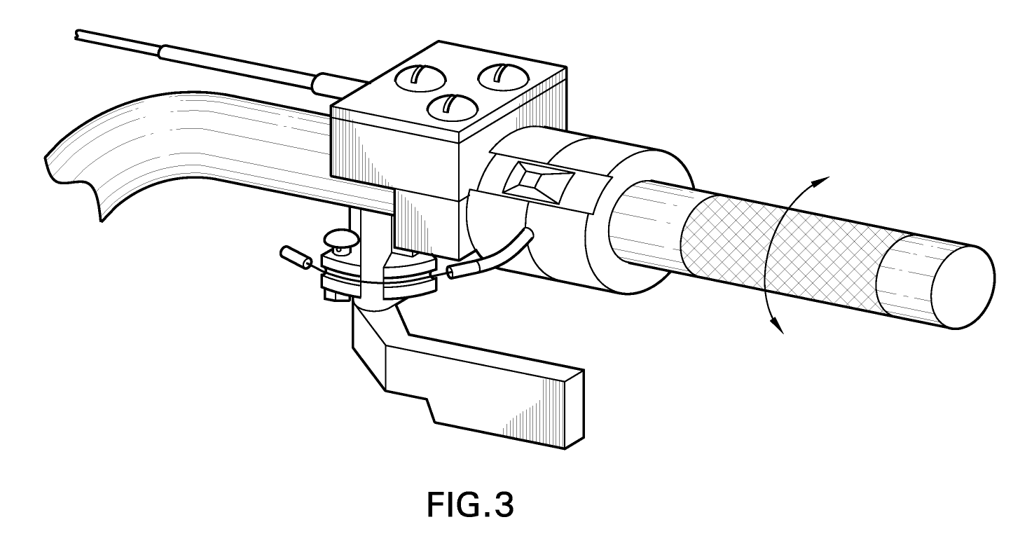

FIG. 3 shows an orthogonal view of the invention with the selector switch handle lock out assembly installed. It can be seen as the Left Half Outer Shell of Select Throttle Assembly (44) and the Right Half Outer Shell of Select Throttle Assembly (45).

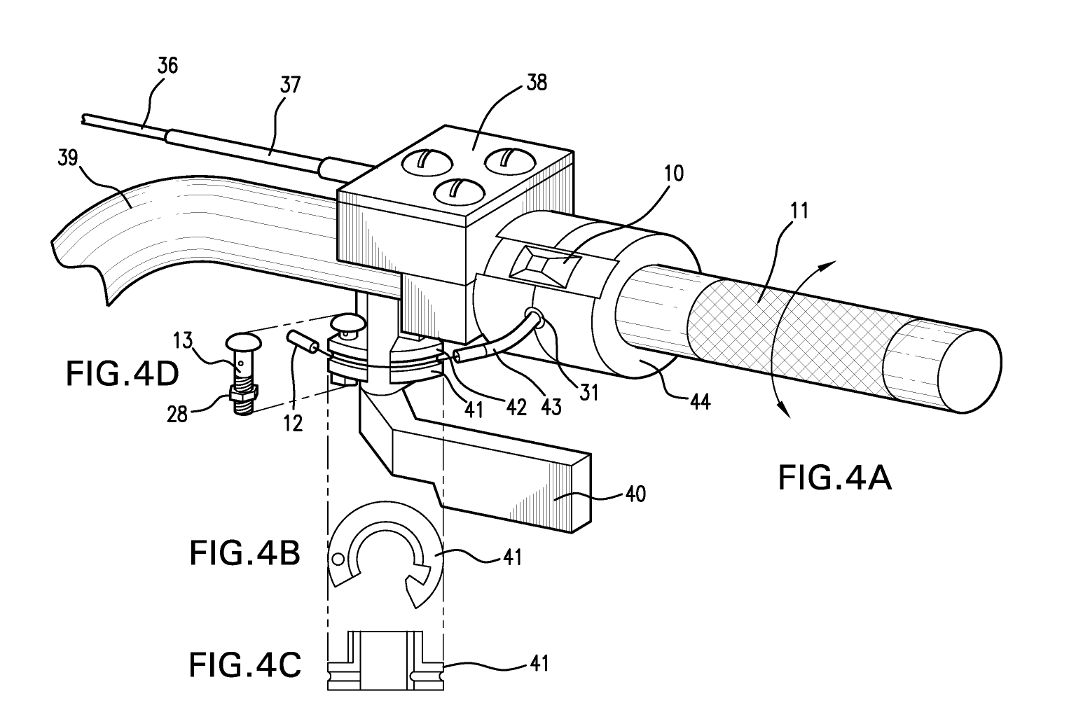

FIG. 4a shows an orthogonal view of the selector switch handle lock out assembly installed with more of the component parts comprising it numbered. As in FIG. 1, a Standard Throttle Cable (36) connected to an engine acceleration means (not shown) which remains as the first throttle cable when the invention is installed is still enclosed inside a Standard Cable Housing (37) which is still attached to a Factory Control Box (39). However with the invention installed the Standard Handlebar (39) extending out of the Factory Control Box (39) now has over the Standard Handlebar on its distal end a Twist Handle Grip (11). This Twist Handle Grip extends out of the Right Half Outer Shell (45) of the Select Throttle Assembly.

The Left Half of the Outer Shell (29) of the Select Throttle Assembly is connected to the Factory Control Box (39) on the right side. A Throttle Select Lock Out Switch (10) located between these two halves is the switching means to select between a thumb actuated throttle and a motorcycle twist type throttle. The selector switch handle lock out assembly includes all of the parts it interfaces with in order to accomplish this lock out function.

A Factory Thumb Lever (40) still extends from the bottom of the Factory Control Box (39), but between the Factory Thumb Lever (40) and the Factory Control Box (39) can be seen the Throttle Pull Wheel (41) which by a cam mediated action changes the length of the Second Throttle Cable (42) entering the Throttle Cable Housing (43) which enters the two halves of the Select Throttle at the Throttle Cable Cover Exit Orifice (31).

A Crimped Cable Ferrule (12) is used to prevent the Second Throttle Cable (42) from pulling through the Select Throttle Cable Adjustment Clamp Screw (13).

When in “Thumb Throttle Mode” the cable is actuated by the user by depressing the Thumb Lever (40). When in “Twist Throttle Mode”, the throttle is actuated by twisting the Twist Handle Grip (11).

The actual choice of which throttle method is used when utilizing the selector switch handle lock out assembly is selected by moving the small square button (10) Shown in FIG. 3 to the left or the right.

(Note: For all of this specification, the entire apparatus could be reversed and the system could be installed on the left side handlebar if desired).

FIG. 4b is a top view of the throttle pull wheel.

FIG. 4c is a side view of the throttle pull wheel. Throttle Pull Wheel (41) uses cam mediated action to change the length of the Second Throttle Cable (42) entering the Throttle Cable Housing (43). The second throttle cable (42) is aligned inside the cable channel inside the spool cable guide so that it exits towards the throttle pull wheel. In another embodiment a cam may be used instead of a throttle pull wheel.

FIG. 4d is a side view of Select throttle cable adjustment clamp screw. The Cable Adjustment Clamp Screw (13) allows the length of the Second Throttle Cable to be adjusted. The operator tightens the Second Throttle Cable (42) by a Cable Adjustment Clamp Nut (28).

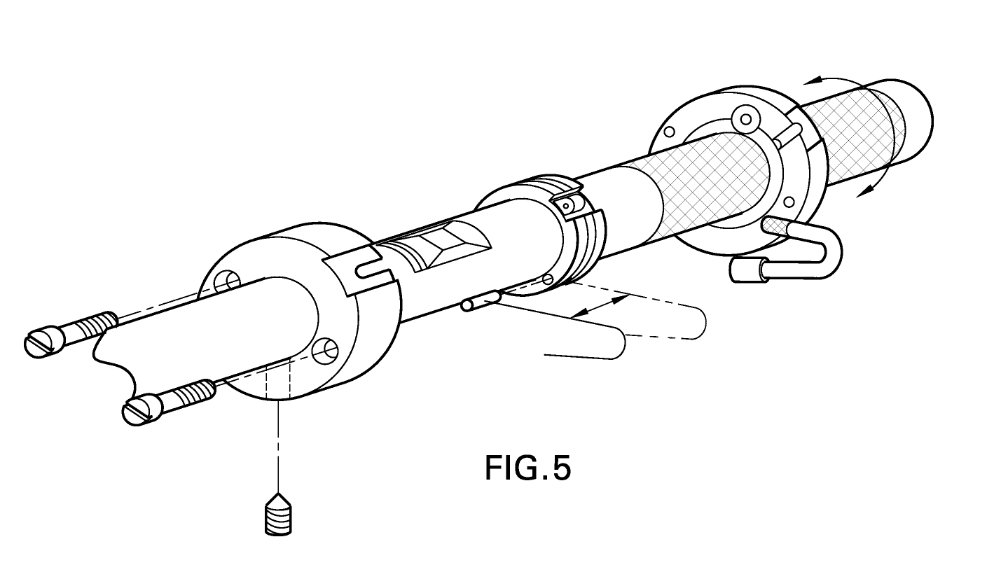

FIG. 5 is an orthogonal exploded view of the selector switch handle lock out assembly wherein the two halves of the outer shell have been pulled apart.

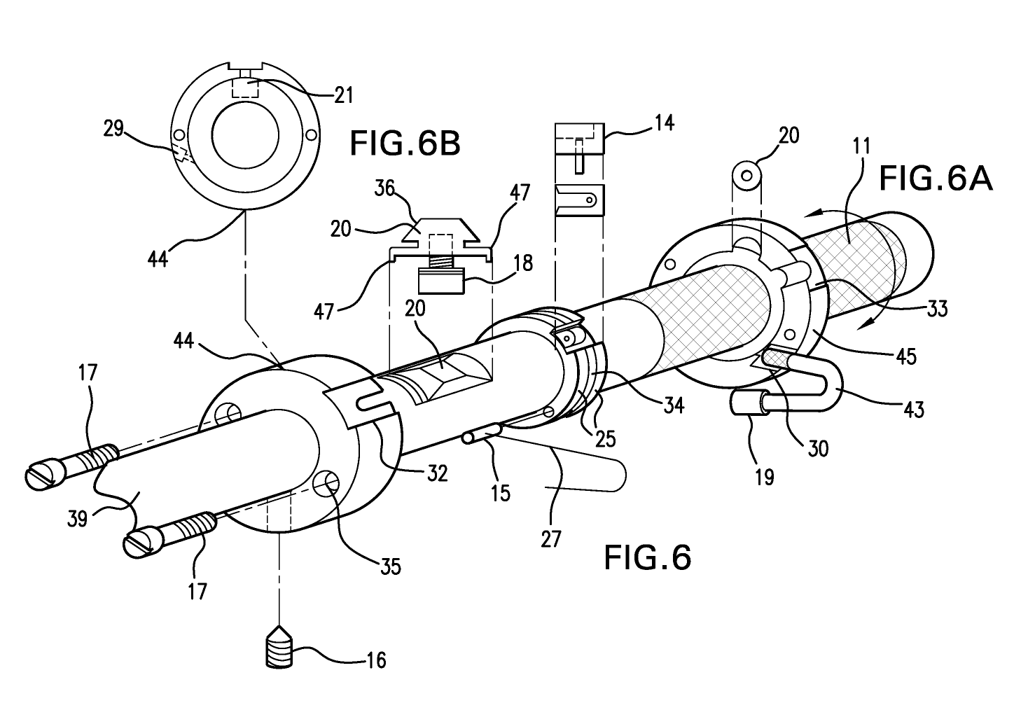

FIG. 6a is an orthogonal exploded view of the selector switch handle lock out assembly. The Standard Handlebar (39) has slid over it the Left Half Outer Shell of the Select Throttle Assembly (44) and the Right Half Outer Shell of Select Throttle Assembly (45) which are connected to the Twist Handle (11) on the distal side. In the preferred embodiment the Twist Throttle Handle is attached to the right half outer shell on the distal side away from the center of the handlebars. In the preferred embodiment, the spool cable guide and the twist throttle handle are manufactured as one piece.

The Left Half Outer Shell of the Select Throttle Assembly (44) is anchored to the Standard Handlebar (39) by the Left Handle Bar Clamp Screw (16). In the preferred embodiment a standard type of set screw means is used to attach the Left Half Outer Shell to the Standard Handlebar.

In the preferred embodiment, the Left Half Outer Shell of the Select Throttle Assembly (44) and the Right Half Outer Shell of Select Throttle Assembly (45) are held together at the point of attachment by a pair or a plurality of Throttle Body Assembly Clamp Screws (17) which are secured through the Through-holes for Assembly (35).

In between the Left Half Outer Shell (44) and the Right Half Outer Shell (45) can be seen the Spool Cable Guide (25) over which the Twist Throttle Cable (27) rides in the Throttle Cable Channel (34). This Spool Cable Guide (25) is comprised of a left half outer shell with a small channel in its outer surface perpendicular to the axis of the shell and a right half outer shell with a small channel in its outer surface perpendicular to the axis of the shell matching the left half outer shell channel. The left half outer shell and right half outer shell when secured together contain an intrusion into the spool cable guide channel guide to keep the spool cable guide channel aligned and the second throttle cable inside the channel. In the preferred embodiment, the twist grip for the twist throttle is mounted on an assembly composed of a right half outer shell and a left half outer shell. In the preferred embodiment, the intrusion into the spool cable guide channel guide to keep the spool cable guide channel aligned and the second throttle cable inside the channel is comprised of a small plain washer. In the preferred embodiment, the small plain washer used to keep the spool cable guide channel aligned and the second throttle cable inside the channel is seated inside a matching cavity existing equally in the mating surfaces of the left half outer shell and right half outer shell.

The Twist Throttle Cable (27) is anchored to the Spool Cable Guide (25) by the Cable Anchor Point Assembly (15).

The Slideable Channel Stop (14) for the Throttle Select Lock Out Switch (10) is a part that can be moved horizontally between the Left Side of the Throttle Selector Channel (32) and the Right Side Channel of the Throttle Selector (33) by the operator switching the apparatus from “Thumb Throttle Mode” to “Twist Throttle Mode” at will. Moving the Lock Out Switch while the “Thumb Throttle” Mode handle is in a locked position (10) causes the Throttle Choice Selector Actuating Lever Screw (18) to engage the Spool Cable Guide (25) which actuates either the First Throttle Cable (27) connected to the Twist Throttle or the Second Throttle Cable (42). The spool cable guide is attached to the twist throttle so that twisting the twist throttle will rotate the spool cable guide. The second throttle cable (42) is aligned inside the cable channel inside the spool cable guide so that it exits towards the throttle pull wheel. The second throttle cable is aligned along the outer edge of the throttle pull wheel such that rotational movement of the twist throttle handle will cause the throttle pull wheel to actuate the first throttle cable. Typically, the throttle pull wheel is in line vertically with the thumb lever.

The throttle choice selector activating lever pin is affixed to the throttle select lock out switch and the channel lock such that moving the throttle select lock out switch will engage or disengage the spool cable guide which has the second throttle cable inside its throttle cable channel. In the preferred embodiment the Throttle Choice Selector Activating Lever Pin is a small socket head bolt.

The Throttle Choice Selector Actuating Lever Screw (18) is held in place in the Left Side of the Throttle Selector Channel (32) and the Right Side Channel of the Throttle Selector (33) by the Throttle Selector Switch (10).

In the preferred embodiment of the selector switch handle lock out assembly, the Lock Out Switch (10) has a small flange (47) or “lip” extending on each side of its base into the Throttle Selector Channels (32) and (33). As a safety mechanism the Throttle Select Switch must be depressed so as to raise the small flange (47) or “lip” from the outside edge of the Outer Shell, allowing it to be moved to the right or to the left. This prevents the Throttle Select Switch from accidentally changing throttle modes unintentionally. The switch from one type of throttle to the other can be made anytime just by flicking this switch to the left or the right, but it must be depressed before it is allowed to move to release these two flanges. These two flanges must be depressed in order for the type of throttle system desired to be chosen.

Also in the preferred embodiment, there is a Twist Throttle Cable Housing (43) which exits the Left Half of the Throttle Cable Cover Exit Orifice (46) and the Right Half of the Throttle Cable Cover Exit Orifice (30) and ends in a Throttle Cable Wiper (19). In the preferred embodiment, a Twist Throttle Cable Stop (20) prevents the Twist Throttle Cable from being activated beyond a pre-selected point.

FIG. 6b is a side view of the left half of the Outer Shell of the Select throttle assembly showing the Left Side Channel & Stop for Selector Actuator Screw (21) and the Left Half of Throttle Cable Cover Exit Orifice (46) of the Left Half Outer Shell of

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for selecting a throttle type using a selector switch handle lock out comprising:
a first throttle cable;
the first throttle cable connected at one end to an engine acceleration means;
a control box means;
the other end of the first throttle cable attached to the control box means;
a handlebar;
the handlebar attached to the control box means;
a left half outer shell with a small channel in its outer surface perpendicular to the axis of the shell;
a right half outer shell with a small channel in its outer surface perpendicular to the axis of the shell matching the left half outer shell channel;
the left half outer shell and right half outer shell attached to the handlebar by an attachment means;
the left half outer shell and right half outer shell secured together by an attachment means;
a slideable channel stop that can be moved from the right half outer shell channel to the left half outer channel shell at will;
a throttle select lock out switch attached to the slideable channel stop;
a twist throttle handle;
the twist throttle handle attached to the right half outer shell on the distal side away from the center of the handlebars;
a thumb lever;
the thumb lever connected to the control box means so as to actuate the first throttle cable;
a throttle pull wheel;
the thumb lever attached to the throttle pull wheel;
a spool cable guide;
the spool cable guide inside the left half outer shell and right half outer shell;
the spool cable guide attached to the twist throttle so that twisting the twist throttle will rotate the spool cable guide;
a cable channel inside the spool cable guide;
a second throttle cable;
one end of the second throttle cable attached to an anchor point on the spool cable guide;
the other end of the second throttle cable attached to the throttle pull wheel;
the second throttle cable aligned inside the cable channel inside the spool cable guide so that it exit towards the throttle pull wheel;
the second throttle cable aligned along the outer edge of the throttle pull wheel such that rotational movement of the twist throttle handle will cause the throttle pull wheel to actuate the first throttle cable;
a throttle choice selector activating lever pin; and
the throttle choice selector activating lever pin affixed to the throttle select lock out switch and the channel lock such that moving the throttle select lock out switch will engage or disengage the spool cable guide which has the second throttle cable inside its throttle cable channel.

2. A machine for selecting a throttle type as claimed in claim 1 wherein the lock out switch has a small flange extending on each side of its base into the throttle selector channels so that that as a safety mechanism the throttle select switch must be depressed so as to raise the small flange from the outside edge of the outer shell, before the switch can be allowed to move to the right or to the left to prevent the throttle select switch from accidentally changing throttle modes unintentionally.

3. A machine for selecting a throttle type as claimed in claim 1 wherein the throttle cable housing enters the two halves of the select throttle assembly at the throttle cable cover exit orifice.

4. A machine for selecting a throttle type as claimed in claim 1 wherein a twist throttle cable stop prevents the twist throttle cable from being activated beyond a pre-selected point.

5. A machine for selecting a throttle type as claimed in claim 1 wherein the throttle pull wheel uses a cam mediated action to change the length of the second throttle cable.

6. A machine for selecting a throttle type as claimed in claim 1 wherein the throttle choice selector activating lever pin is a small socket head bolt.

7. A machine for selecting a throttle type as claimed in claim 1 wherein the left half outer shell and right half outer shell when secured together contain an intrusion into the spool cable guide channel guide to keep the spool cable guide channel aligned and the second throttle cable inside the channel.

8. A machine for selecting a throttle type as claimed in claim 1 wherein the twist grip is mounted on an assembly composed of a right half outer shell and a left half outer shell.

9. A machine for selecting a throttle type as claimed in claim 1 wherein the throttle pull wheel is in line vertically with the thumb lever.

10. A machine for selecting a throttle type as claimed in claim 1 wherein a cam is used instead of a throttle pull wheel.

11. A machine for selecting a throttle type as claimed in claim 1 wherein the left half outer shell and right half outer shell are secured together by an attachment means comprised of a plurality of throttle body assembly clamp screws.

12. A machine for selecting a throttle type as claimed in claim 1 wherein the spool cable guide and the twist throttle handle are manufactured as one piece.

13. A machine for selecting a throttle type as claimed in claim 15 wherein the intrusion into the spool cable guide channel guide to keep the spool cable guide channel aligned and the second throttle cable inside the channel is comprised of a small plain washer

14. A machine for selecting a throttle type as claimed in claim 21 wherein the small plain washer used to keep the spool cable guide channel aligned and the second throttle cable inside the channel is seated inside a matching cavity existing equally in the mating surfaces of the left half outer shell and right half outer shell.
